(19) United States
(12) Patent Application Publication
(10) Pub. No.: US 2011/0216770 A1
(43) Pub. Date: Sep. 8, 2011

(54) METHOD AND APPARATUS FOR ROUTING NETWORK PACKETS AND RELATED PACKET PROCESSING CIRCUIT

(76) Inventor: Pei-Lin WU, Hsinchu (TW)

(21) Appl. No.: 12/765,663

(22) Filed: Apr. 22, 2010

(30) Foreign Application Priority Data
Mar. 4, 2010 (TW) 099106304

(51) Int. Cl. H04L 12/56

(52) U.S. Cl. 370/392

(57) ABSTRACT

A packet processing circuit for use in a routing device is disclosed including: an input/output interface; and a processor coupled with input/output interface for, when receiving a first network packet having a destination network protocol address addressed to an external network section and having a destination physical address different from the physical address of the routing device, generating a second network packet having a destination network protocol address the same as the first network packet and having a source physical address the same as the physical address of the routing device.

### BACKGROUND OF THE INVENTION

1. Field of the Invention

The present invention relates to network communication apparatuses, and more particularly, to routing devices and related packet processing circuits capable of routing cross-subnet packets transmitted from a terminal device with poisoned ARP information.

2. Description of Related Art

Internet related applications have widely and deeply penetrated into many people's life, work, entertainment, and other various aspects. Information security issues thus become more and more important. However, the patterns and dissemination means of network security threats, such as network viruses and incursions, also evolve continuously from time to time.

For many local area network environments, network security threats and attacks from external network should be avoided, but security threats from the internal network infrastructure are also a big problem. For example, Address Resolution Protocol (ARP) information (a.k.a. ARP table or ARP cache) plays an important role in Ethernet communications, but attackers or malicious programs could easily create forged ARP packets by using so-called ARP spoofing approaches to poison the ARP information of terminal devices in the local area network since the ARP protocol is imperfect.

Common ARP attacks would poison the router's address resolution recorded in the ARP information of a terminal device, and thus render the terminal device to fill in the header of a network packet to be transmitted to the router with an incorrect destination physical address (such as MAC address) different from the actual physical address of the router. Under conventional communication protocol, when received network packets from the affected terminal devices, the router would discard the network packets because the destination physical addresses of the network packets are not addressed to the router's physical address, and this would cause the affected terminal devices to be unable to access to other network sections or Internet.

When such problem occurs, it would cause severe inconvenience to users. In order to recover the network access capacity of the affected terminal devices, the network administrator has to manually check and fix the ARP information of the affected terminal devices one by one, which is a time-consuming and troublesome work.

To reduce ARP attacks in the local area network, a conventional solution is to install a VLAN switch in the local area network. The VLAN switch is utilized to isolate the connection among terminal devices within the local area network in the physical layer, so that forged ARP packets are difficult to propagate among terminal devices. As a result, the possibility that ARP attacks poison or destroy the ARP information of the terminal device can be reduced.

The addition of the VLAN switch, however, not only introduces extra cost, but also increases the complexity of the infrastructure topology of the local area network. For small network environments or home-use network applications, the VLAN switch approach is not an economic solution.

### SUMMARY OF THE INVENTION

In view of the foregoing, it can be appreciated that a substantial need exists for methods and apparatuses that can mitigate or reduce the threats and inconvenience for the terminal devices in the local area network caused by the ARP attacks.

An exemplary embodiment of packet processing circuit for use in a routing device for routing network packets from terminal devices within a first network section is disclosed. The packet processing circuit comprises: an input/output interface; and a processor coupled with the input/output interface for, when receiving a first network packet having a destination network protocol address (e.g., IPv4 address or IPv6 address) addressed to an external network section and having a destination physical address different from a physical address of the routing device, generating a second network packet having a destination network protocol address identical to that of the first network packet and having a source physical address identical to the physical address of the routing device.

An exemplary embodiment of routing device for routing network packets from terminal devices within a first network section is disclosed. The routing device comprises: a storage medium for storing routing information; a first network interface for receiving network packets; a processor coupled with the storage medium and the first network interface for, when receiving a first network packet having a destination network protocol address addressed to a second network section, generating a second network packet having a destination network protocol address identical to that of the first network packet and having a source physical address identical to a physical address of the routing device based on the first network packet regardless of whether a destination physical address of the first network packet is identical to the physical address of the routing device; and a second network interface coupled with the processor for transmitting the second network packet toward a next hop according to the routing information.

It is to be understood that both the foregoing general description and the following detailed description are exemplary and explanatory only and are not restrictive of the invention, as claimed.

### BRIEF DESCRIPTION OF THE DRAWINGS

FIG. 1 is a simplified block diagram of a network system in accordance with an exemplary embodiment.

FIG. 2 is a simplified block diagram of the packet processing circuit of FIG. 1 in accordance with an exemplary embodiment.

FIG. 3 is a flowchart illustrating a method for routing packets in accordance with an exemplary embodiment.

### DETAILED DESCRIPTION

Reference will now be made in detail to exemplary embodiments of the invention, which are illustrated in the accompanying drawings. The same reference numbers may be used throughout the drawings to refer to the same or like parts or operations.

Certain terms are used throughout the description and following claims to refer to particular components. As one skilled in the art will appreciate, vendors may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . .” Also, the phrase “coupled with” is intended to compass any indirect or direct connection. Accordingly, if this document mentioned that a first device is coupled with a second device, it means that the first device may be directly connected to the second device (including through an electrical connection or other signal connections, such as wireless communications or optical communications), or indirectly connected to the second device through an indirect electrical connection or signal connection via other intermediate device or connection means.

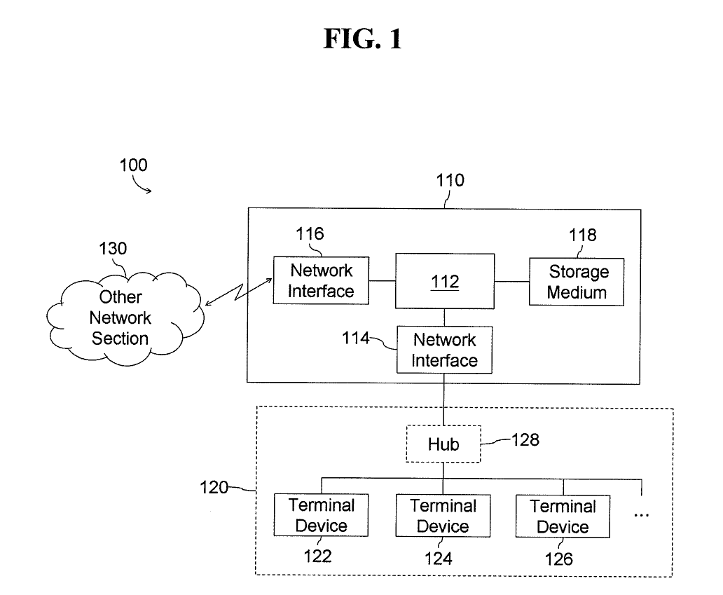

FIG. 1 shows a simplified block diagram of a network system 100 in accordance with an exemplary embodiment. In the network system 100, a routing device (also referred to as a communication gateway) 110 is the communication bridge between a local area network 120 and other network section (e.g., Internet) 130. The routing device 110 of this embodiment comprises a packet processing circuit 112, a network interface 114 for communicating with the local area network 120, a network interface 116 for communicating with other network 130, and a storage medium 118. In implementations, the routing device 110 may be dedicated network equipment, or may be implemented by installing a software program or operation system with packet routing/forwarding function into a computer.

The communications between the routing device 110 and the local area network 120, or the communications between the routing device 110 and other network 130 can be implemented by either wired or wireless transmission approaches. Thus, the network interface 114 and the network interface 116 may be wired network interfaces or wireless communication interfaces. The storage medium 118 is utilized for storing routing information and ARP information required for the operations of the routing device 110. The storage medium 118 may be implemented by storage devices built in the routing device 110, external storage devices, or the combination of above.

As shown in FIG. 1, the local area network 120 comprises multiple terminal devices (terminal devices 122, 124, and 126 are shown as examples). These terminal devices may be cell-phones, computers, PDAs, set-top boxes, game stations or any other equipment with network access capability. In implementations, the multiple terminal devices in the local area network 120 may be communicated with each other via one or more hubs (or switch) 128 using wired or wireless transmission means to constitute a more complex, or larger local area network environment, and coupled with the network interface 114 of the routing device 110.

In the local area network 120, each of the terminal devices 122, 124, and 126 obtains physical address (e.g., MAC address) and network protocol address (e.g., IPv4 address or IPv6 address) pairing information of the routing device 110 and other terminal devices through ARP packets, and updates its own ARP information accordingly. For illustrative purpose, it is assumed hereafter that the routing device 110 has a physical address MAC_110 and a network protocol address IP_110; the terminal device 122 has a physical address MAC_122 and a network protocol address IP_122; the terminal device 124 has a physical address MAC_124 and a network protocol address IP_126; and the terminal device 126 has a physical address MAC_126 and a network protocol address IP_126.

In normal situations, the MAC_110 and IP_110 pair, the MAC_124 and IP_124 pair, and the MAC_126 and IP_126 pair would be recorded in the ARP information of the terminal device 122. The MAC_110 and IP_110 pair, the MAC_122 and IP_122 pair, and the MAC_126 and IP_126 pair would be recorded in the ARP information of the terminal device 124. The MAC_110 and IP_110 pair, the MAC_122 and IP_122 pair, and the MAC_124 and IP_124 pair would be recorded in the ARP information of the terminal device 126.

Therefore, when the terminal device 122 would like to transmit a network packet A to a destination network device, the terminal device 122 fills in the source physical address field of the network packet A with its own physical address MAC_122 and fills in the source network protocol address field of the network packet A with its own network protocol address IP_122. If the destination network device is a network device located within the same network section (it is assumed that the destination network device is the terminal device 124 for illustrative purposes), the terminal device 122 fills in the destination physical address field and the destination network protocol address field of the network packet A with the physical address MAC_124 and the network protocol address IP_124 of the terminal device 124, respectively. If the destination network device is a web server on the Internet and has a network protocol address IP_Web, the terminal device 122 fills in the destination physical address field of the network packet A with the physical address MAC_110 of the router 110, and fills in the destination network protocol address field of the network packet A with the network protocol address IP_Web of web server.

With the foregoing method, each of the terminal devices 122, 124, and 126 in the local area network 120 can communicate with other terminal devices within the same network section, and are also able to communicate with network devices in other network 130 via the routing device 110.

However, when ARP attacks occur in the local area network 120, each terminal device may receive forged ARP packets and cause the ARP information of the terminal device to be poisoned accordingly.

For example, it is assumed that the terminal deice 124 is manipulated by a malicious user or affected by computer viruses and thus utilizes ARP spoofing means to broadcast a ARP packet with the network protocol address IP_110 of the communication gateway (i.e., the routing device 110) and a forged physical address MAC_X pairing to other terminal devices 122 and 126 in the local area network 120. When the terminal devices 122 and 126 received the forged ARP broadcast packet, they will modify their original ARP information by changing the address resolution entry corresponding to the routing device 110 from the IP_110 and MAC_110 pairing to the incorrect IP_110 and MAC_X pairing.

Afterward, when the terminal device 122 would like to transmit a network packet B to a destination network device in other network 130, the terminal device 122 would fill in the destination network protocol address field of the network packet B with the network protocol address of the destination address, and fill in the destination physical address field of the network packet B with the erroneous physical address MAC_X.

When the routing device 110 receives the network packet B, the routing device 110 would simply discard the network packet B if it follows the traditional routing protocol, because the address MAC_X recorded in the destination physical address field of the network packet B is different from the physical address MAC_110 of the routing device 110. This, however, would cause the terminal device 122 to be unable to access to the destination network device in other network 130, e.g., to be unable to access the Internet.

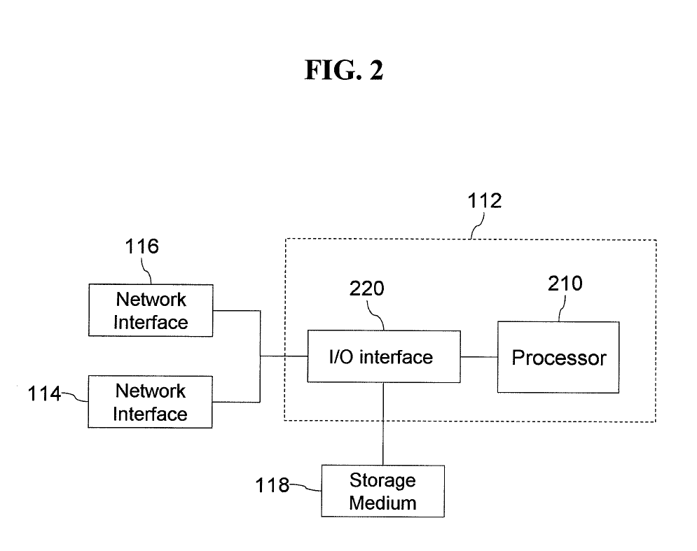

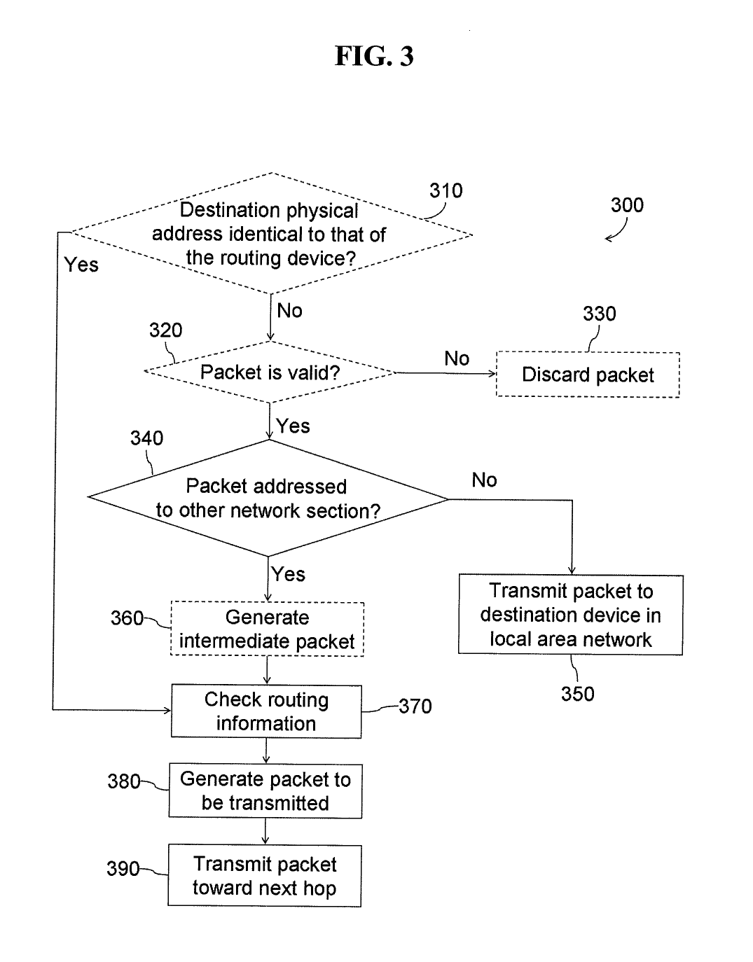

To avoid such undesirable situation, the routing device 110 of this embodiment utilizes a routing method different from the prior art method to process the received network packets so as to maintain the network access capability for the terminal devices in the local area network 120. Hereinafter, operations of the routing device 110 will be described with reference to FIG. 2 through FIG. 3.

FIG. 2 is a simplified block diagram of the packet processing circuit 112 in accordance with an exemplary embodiment. In this embodiment, the packet processing circuit 112 comprises a processor 210 and an input/output interface 220. The input/output interface 220 is coupled with the network interface 114, the network interface 116, and the storage medium 118 of the routing device 110, for transmitting data among the processor 210 and the network interfaces 114, 116, and the storage medium 118.

FIG. 3 shows a flowchart 300 illustrating the method for routing packets in accordance with an exemplary embodiment. When the network interface 114 of the routing device 110 receives a network packet C transmitted from the terminal device 122, the processor 210 of the packet processing circuit 112 performs an operation 310 to check whether the content of the destination physical address field of the network packet C is identical to the physical address MAC_110 of the routing device 110. If the destination physical address field of the network packet C is filled with the physical address MAC_110 of the routing device 110, the processor 210 proceeds to an operation 370.

If the content of the destination physical address field of the network packet C is not the physical address MAC_110 of the routing device 110, then the processor 210 proceeds to an operation 320. Taking the aforementioned situation where the ARP information of the terminal device 122 is poisoned by forged ARP packets as an example, the terminal device 122 would fill in the destination physical address field of the network packet C with MAC_X, not the physical address MAC_100 of the routing device 110. When encounters this situation, the packet processing circuit 112 does not follow the traditional Ethernet protocol to discard the network packet C. Instead, the packet processing circuit 112 of this embodiment proceeds to the operation 320.

In the operation 320, the processor 210 determines whether the network packet C is a valid packet. In implementations, the processor 210 may rely on the source address information of the network packet C to determine whether the network packet C is a valid packet. The term “source address” as used herein may be refer to the source network protocol address or the source physical address of a network packet, or the combination of the above two. In one embodiment, for example, the processor 210 determines that the network packet C comprises a valid source address if either the source network protocol address or the source physical address of the network packet C, or both of them are within the network section that is handled by the routing device 110, and thereby determining that the network packet C is a valid packet.

In another embodiment, the processor 210 exams the ARP information stored in the storage medium 118 and determines that the network packet C comprises a valid source address if either the source network protocol address or the source physical address of the network packet C, or the pairing of above two is recorded in the ARP information, and thereby determining that the network packet C is a valid packet.

In another embodiment, the processor 210 determines that the network packet C comprises a valid source address (and thus the network packet C is a valid packet) if the pairing of the source network protocol address and the source physical address of the network packet C is recorded in the ARP information stored in the storage medium 118 and set by the network administrator. For example, if the pairing of the source network protocol address and the source physical address of the network packet C is recorded in the ARP information stored in the storage medium 118, and the type of the pairing information is set as “Static,” the processor 210 may accordingly determine that the pairing information is set by the network administrator and thus determine that the network packet C comprises a valid source address.

In addition, the processor 210 may rely on other information related to the source address of the network packet C to determine whether the network packet C is a valid packet. For example, the processor 210 may record connection related data (such as connection frequency, connection times, and/or last connected time, etc.) with respect to other network sections for the address of each terminal device within the local area network handled by the routing device 110. When the processor 210 detected that data related to the connection to other network sections of the source network protocol address or the source physical address of the network packet C satisfies a predetermined criterion (e.g., the connection frequency is over a threshold frequency and/or the connection times is higher than a threshold value), the processor 210 may thus determine that the source network protocol address or the source physical address is within the network section handled by the routing device 110, thereby determining that the network packet C comprises a valid source address and is therefore a valid packet. The threshold frequency and threshold value described previously may be either fixed values or adjustable by the network administrator based on the environment or application characteristics of the network structure.

In implementations, the algorithm of the processor 210 may be designed such that the processor 210 determines that the network packet C comprises a valid source address and is a valid packet only if the source address of related data of the network packet C satisfies two of more conditions set forth above. Alternatively, other packet authentication mechanism, source address authentication mechanism, or security authentication mechanism may be used to determine whether the network packet C comprises a valid source address or whether the network packet C is a valid packet.

If the processor 210 determines that the network packet C does not comprise a valid source address or not a valid packet in the operation 320, it proceeds to an operation 330 to discard the network packet C. If the processor 210 determines that the network packet C comprises a valid source address or is a valid packet, then it proceeds to an operation 340.

In the operation 340, the processor 210 read the value of the destination network protocol address field of the network packet C, and accordingly determines the destination of the network packet C is within the network section handled by the routing device 110 or is addressed to other network 130.

If the destination network protocol address of the network packet C is addressed to another terminal device (which is assumed the terminal device 126 here) within the same network section, then the processor 210 proceeds to an operation 350.

In the operation 350, the packet processing circuit 112 transmits the network packet C toward a destination device corresponding to the physical address MAC_126 (i.e., the terminal device 126 within the local area network 120 in this embodiment) via the network interface 114. In some embodiments, the processor 210 may perform predetermined processes, such as virus scanning, packet filtering, or other treatments of the application layer, on the network packet C before conducting the operation 350.

If the processor 210 in the operation 340 detected that the destination network protocol address of the network packet C is addressed to a destination device (assuming its network protocol address is IP_WAN) of other network 130, the processor 210 determines that the source device of the network packet C (i.e., the terminal device 122 in this case) is affected by ARP attacks. Therefore, in order to avoid inconvenience to the user caused by the interrupt of network accessing function of the terminal device 122, the processor 210 of one embodiment proceeds to an operation 360 and may issue a warning notice to the network administrator based on predetermined security rules.

In the operation 360, the processor 210 changes the content of the destination physical address field of the network packet C to the physical address MAC_110 of the routing device 110 to generate an intermediate network packet C′.

In the operation 370, the processor 210 checks the routing information stored in the storage medium 118 to find out a corresponding routing rule and a corresponding next hop for the network protocol address IP_WAN.

In an operation 380, the processor 210 generates a network packet D to be transmitted based on the intermediate network packet C′. In implementations, the processor 210 may simply utilize the payload of the intermediate network packet C′ as the payload of the network packet D to be transmitted. Alternatively, the processor 210 may perform predetermined processes, such as virus scanning, packet filtering, or other treatments of the application layer, on the payload of the intermediate network packet C′, and utilizes the resulted data as the payload of the network packet D. In addition, the processor 210 further set the destination protocol address of the network packet D as identical to the destination protocol address IP_WAN of the intermediate network packet C′ (or the network packet C), and fills in the source physical address field of the network packet D with the physical address MAC_110 of the routing device 110. In other words, the processor 210 generates the network packet D having a destination network protocol address identical to the destination network protocol address IP_WAN of the network packet C and having a source physical address identical to the physical address MAC_110 of the routing device 110.

Then, the packet processing circuit 112 proceeds to an operation 390 to transmit the network packet D toward the next hop obtained in the operation 370 via the network interface 116.

Please note that the order of the operations in the flowchart 300 is merely an example rather than a restriction of the practical implementations. For example, the operation 310, the operation 320, and the operation 330 can be performed in any order. Additionally, in some applications where the local area network 120 has a simple structure (e.g., there is only one network section within the local area network 120), the terminal devices within the local area network 120 rarely change, each newly added terminal device is verified by the network administrator, or the ARP information of the routing device 110 is set and controlled by the network administrator, the operation 310 and/or the operation 320 can be omitted. In implementations, the operation 360 can be omitted.

It can be appreciated from the above descriptions that when the terminal device 122's address resolution information with respect to the routing device 110 is poisoned by ARP attacks, the terminal device 122 would fill in the destination physical address field of the network packet C to be transmitted to other network 130 with erroneous destination physical address. The processor 210 of the packet processing circuit 112 does not discard the network packet C, but perform other verification procedure to evaluate whether the source of the network packet C, i.e., the terminal device 122, is affected by ARP attacks. In the example described previously, the processor 210 detected that the destination network protocol address of the network packet C is addressed to other network 130, but the destination physical address of the network packet C is different from the physical address MAC_110 of the routing device 110, the processor 210 would thus determine that the ARP information of the terminal device 122 is poisoned by ARP attacks. In this situation, the packet processing circuit 112 would continuously perform routing process for the network packet C to convert it into the network packet D and then transmits the network packet D to the correct route, so that the communication between the terminal device 122 and other network section (such as the Internet) will not be interrupted due to the poisoned ARP information of the terminal device 122.

It can also be found from the foregoing descriptions that by employing the routing device 110 the terminal devices within the local area network can be immune from communication interrupt threats caused by the ARP attacks without the use of additional VLAN switches. Therefore, the cost of network infrastructure can be lowered.

Another advantage of the routing device 110 is that it is able to determine whether the source device of the network packets is affected by ARP attacks by simply checking the destination network protocol address and the source address in the header of the network packets, and needs not to consume considerable computing resource to exam the payload of the network packets. Since the routing device 110 can maintain the terminal devices' capacity of communicating with other network sections, the threats for the local area network caused by the ARP attacks can be effectively reduced.

In addition, since the routing deice 110 and related packet processing circuit 112 can maintain the communication between the terminal device and Internet or other network sections even if the terminal device's ARP information is poisoned by ARP attacks, the network administrator no longer needs to check and fix the affected terminal devices' ARP information one by one.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A packet processing circuit for use in a routing device for routing network packets from terminal devices within a first network section, the packet processing circuit comprising:
an input/output interface; and
a processor coupled with the input/output interface for, when receiving a first network packet having a destination network protocol address addressed to an external network section and having a destination physical address different from a physical address of the routing device, generating a second network packet having a destination network protocol address identical to that of the first network packet and having a source physical address identical to the physical address of the routing device.

2. The packet processing circuit of claim 1, wherein the processor generates the second network packet only if the first network packet is a valid packet or comprises a valid source address.

3. The packet processing circuit of claim 1, wherein the processor generates an intermediate packet having a destination network protocol address identical to that of the first network packet and having a destination physical address identical to the physical address of the routing device, and then generates the second network packet based on the intermediate packet.

4. The packet processing circuit of claim 1, wherein the processor generates the second network packet only if the first network packet satisfies at least one of the following conditions:
(a) a source address of the first network packet is within the first network section;
(b) a source address of the first network packet is recorded in the ARP information of the routing device;
(c) a source address of the first network packet is set by a network administrator; or
(d) a source address of the first network packet has a connection frequency with respect to network sections other than the first network section higher than a predetermined threshold.

5. The packet processing circuit of claim 1, wherein the processor utilizes data obtained by performing a predetermined process on the payload of the first network packet as the payload of the second network packet.

6. A routing device for routing network packets from terminal devices within a first network section, the routing device comprising:
a storage medium for storing routing information;
a first network interface for receiving network packets;
a processor coupled with the storage medium and the first network interface for, when receiving a first network packet having a destination network protocol address addressed to a second network section, generating a second network packet having a destination network protocol address identical to that of the first network packet and having a source physical address identical to a physical address of the routing device based on the first network packet regardless of whether a destination physical address of the first network packet is identical to the physical address of the routing device; and
a second network interface coupled with the processor for transmitting the second network packet toward a next hop according to the routing information.

7. The routing device of claim 6, wherein the processor generates the second network packet only if the first network packet is a valid packet or comprises a valid source address.

8. The routing device of claim 6, wherein the processor generates an intermediate packet having a destination network protocol address identical to the first network packet and having a destination physical address identical to the physical address of the routing device, and then generates the second network packet based on the intermediate packet.

9. The routing device of claim 6, wherein the processor generates the second network packet only if the first network packet satisfies at least one of the following conditions:
(a) a source address of the first network packet is within the first network section;
(b) a source address of the first network packet is recorded in the ARP information of the routing device;
(c) a source address of the first network packet is set by a network administrator; or
(d) a source address of the first network packet has a connection frequency with respect to network sections other than the first network section higher than a predetermined threshold.

10. The routing device of claim 6, wherein the processor utilizes data obtained by performing a predetermined process on the payload of the first network packet as the payload of the second network packet.

11. A method for processing network packets, comprising:
(a) receiving a first network packet using a routing device;
(b) retrieving a destination physical address of the first network packet;
(c) retrieving a destination network protocol address of the first network packet; and
(d) if the destination physical address different from a physical address of the routing device and the destination network protocol address addressed to an external network section, generating a second network packet having a destination network protocol address identical to that of the first network packet and having a source physical address identical to the physical address of the routing device.

12. The method of claim 11 further comprising:
transmitting the second network packet toward a next hop according to routing information.

13. The method of claim 11, wherein operation (d) generates the second network packet only if the first network packet is a valid packet or comprises a valid source address.

14. The method of claim 11, wherein the operation (d) generates the second network packet only if a source address of the first network packet satisfies at least one of the following conditions:
(e1) the source address comprises a network protocol address/physical address within the first network section;
(e2) the source address comprises a network protocol address/physical address recorded in the ARP information of the routing device;
(e3) the source address is set by a network administrator; or
(e4) a connection frequency of the source address with respect to network sections other than the first network section is higher than a predetermined threshold.

15. The method of claim 11, wherein the operation (d) generates the second network packet only if the first network packet satisfies at least one of the following conditions:
(f1) a source address of the first network packet is within the first network section;
(f2) a source address of the first network packet is recorded in the ARP information of the routing device;
(f3) a source address of the first network packet is set by a network administrator; or
(f4) a source address of the first network packet has a connection frequency with respect to network sections other than the first network section higher than a predetermined threshold.

16. The method of claim 11, wherein the operation (d) further comprises:
(d1) utilizing data obtained by performing a predetermined process on the payload of the first network packet as the payload of the second network packet.

17. The method of claim 11, wherein the operation (d) further comprises:
(d1) generating an intermediate packet having a destination network protocol address identical to that of the first network packet and having a destination physical address identical to the physical address of the routing device based on the first network packet, and
(d2) generating the second network packet based on the intermediate packet.
